(19) United States
(12) Patent Application Publication
(10) Pub. No.: US 2024/0427973 A1
(43) Pub. Date: Dec. 26, 2024

(54) Modular Design Flow

(71) Applicant: Coherent Logix, Incorporated, Austin, TX (US)

(72) Inventors: Michael B. Solka, Austin, TX (US); Michael L. Purnell, Scotts Valley, CA (US); Michael R. Trocino, Austin, TX (US); Carl S. Dobbs, Austin, TX (US)

(21) Appl. No.: 18/755,147

(22) Filed: Jun. 26, 2024

Related U.S. Application Data
(60) Provisional application No. 63/510,330, filed on Jun. 26, 2023.

(51) Int. Cl. G06F 30/327; G06F 111/20

(52) U.S. Cl. CPC G06F 30/327; G06F 2111/20

(57) ABSTRACT

Methods and device for constructing a specification data structure for a module of a multiprocessor array (MPA) chip. The specification data structure includes parameters for combining a plurality of register transfer language (RTL) templates for submodules of the modules into an RTL description of the module, parameters for combining a plurality of test bench templates for respective submodules into a test bench for the module, parameters for combining a plurality of physical design script templates for respective submodules into a physical design script for the module, and/or parameters for constructing an API for the module based on a set of functional criteria for module operation. The RTL description, the test bench, the physical design script, and/or the API are constructed and stored in memory for use in designing and fabricating the module.

### PRIORITY INFORMATION

This application claims the benefit of U.S. Provisional Application No. 63/510,330, titled “Modular Design Flow”, and filed on Jun. 26, 2023, which is incorporated by reference herein in its entirety, as though completely set forth herein.

### FIELD OF THE INVENTION

The field of the invention generally relates to development and design for digital electronic systems.

### DESCRIPTION OF THE RELATED ART

Digital electronic systems utilize processors, which in some cases may be implemented on one or more multiprocessor arrays (MPAs). Examples of digital electronic systems include: computers, digital signal processors (DSP), and these systems embedded in enclosing equipment, such as radio telephones, government service radios, consumer wireless equipment such as cellphones, smartphones and tablet computers, cellular base station equipment, video processing and broadcast equipment, object recognition equipment, hyper-spectral image data processing, etc.

An MPA may be loosely defined as a plurality of processing elements (PEs) (i.e., processors), supporting memory (SM), and a high bandwidth interconnection network (IN). The term “array” in the MPA context is used in its broadest sense to mean a plurality of computational units (each containing processing and memory resources) interconnected by a network with connections available in one, two, three, or more dimensions, including circular dimensions (loops or rings). Note that a higher dimensioned MPA can be mapped onto fabrication media with fewer dimensions. For example, an MPA in an IN with the shape of a four-dimensional (4D) hypercube can be mapped onto a 3D stack of silicon integrated circuit (IC) chips, or onto a single 2D chip, or even a 1D line of computational units. Also, low dimensional MPAs can be mapped to higher dimensional media. For example, a 1D line of computation units can be laid out in a serpentine shape onto the 2D plane of an IC chip or coiled into a 3D stack of chips. An MPA may contain multiple types of computational units and interspersed arrangements of processors and memory. Also included in the broad sense of some MPA implementations is a hierarchy or nested arrangement of MPAs, especially an MPA composed of interconnected IC chips where the IC chips contain one or more MPAs which may also have deeper hierarchal structure.

MPAs present new problems and opportunities for software development methods and tools. Since MPAs may extend to thousands of PEs, there is a need to manage large amounts of software to operate the array, and to design, test, debug, and rebuild such software in efficient ways. Generally, this involves modularity, hierarchy, adaptable module re-use, and automated build methods. While these ideas have appeared in conventional software development systems, they have not been integrated into development tools in a way that supports generalized modules that may be adapted statically and/or dynamically to a different number of PEs and other resources depending on performance requirements or a different shape or topology requirement that in turn may depend on resource availability or application requirements.

Accordingly, improved techniques and tools for computer chip design and development are desired.

### SUMMARY OF THE INVENTION

Various embodiments of techniques for developing software for designing and fabricating a hardware module of a computing chip are provided below. In some embodiments, the hardware is a multiprocessor array or a component of a multiprocessor array, which may include a plurality of processors and a plurality of communication elements, as desired.

In some embodiments, a specification data structure is constructed for a hardware module, which may be a multiprocessor array (MPA) chip, or a portion or subset thereof.

In some embodiments, the specification data structure includes parameters for combining a plurality of register transfer language (RTL) templates for submodules of the hardware module into an RTL description of the hardware module, parameters for combining a plurality of test bench templates for respective submodules into a test bench for the hardware module, parameters for combining a plurality of physical design script templates for respective submodules into a physical design script for the hardware module, and/or parameters for constructing an API for the hardware module based on a set of functional criteria for module operation.

In some embodiments, the specification data structure is stored in a non-transitory computer-readable memory medium.

In some embodiments, the RTL description, the test bench, the physical design script, and/or the API are constructed based on the specification data structure and the pluralities of RTL, test bench, physical design script templates, and/or the set of functional criteria. In some embodiments, the RTL description, the test bench and/or the physical design script are used to create manufacturing instructions for fabricating the hardware module (e.g., by a foundry).

In some embodiments, the RTL description, the test bench, the physical design script, and/or the API are stored in the non-transitory computer-readable memory medium.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present invention can be obtained when the following detailed description of the preferred embodiment is considered in conjunction with the following drawings, in which:

FIG. 1 illustrates one embodiment of an exemplary development system, according to some embodiments;

FIG. 2 illustrates an embodiment of an exemplary multiprocessor array (MPA) system, according to some embodiments;

FIG. 3 is a diagram illustrating a workflow for constructing a specification data structure and manufacturing instructions, according to some embodiments;

FIG. 4A is a schematic diagram illustrating how a specification is used to generation modules in multiple domains, according to some embodiments;

FIG. 4B is a simplified schematic illustrating module generation using a specification, according to some embodiments;

FIG. 5 is a schematic diagram illustrating multiple interfaces connected to an MPA, according to some embodiments; and

FIG. 6 is a flowchart diagram illustrating a method for constructing and utilizing a specification data structure, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

The term “configured to” is used herein to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component.

### DETAILED DESCRIPTION OF EMBODIMENTS OF THE INVENTION

### Terms

The following is a glossary of terms used in the present application:

Memory Medium-Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, optical storage, or ROM, EPROM, FLASH, etc., The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical or optical signals.

Programmable Hardware Element-includes various hardware devices comprising multiple programmable function blocks connected via a programmable or hardwired interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Application Specific Integrated Circuit (ASIC)—this term is intended to have the full breadth of its ordinary meaning. The term ASIC is intended to include an integrated circuit customized for a particular application, rather than a general purpose programmable device, although ASIC may contain programmable processor cores as building blocks. Cell phone cell, MP3 player chip, and many other single-function ICs are examples of ASICS. An ASIC is usually described in a hardware description language such as Verilog or VHDL.

Program—the term “program” is intended to have the full breadth of its ordinary meaning. The term “program” includes 1) a software program which may be stored in a memory and is executable by a processor or 2) a hardware configuration program useable for configuring a programmable hardware element or ASIC.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, e.g., imperative or procedural languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element or ASIC.

Computer System—any of various types of computing or processing systems, including a personal computer system (PC), mainframe computer system, workstation, network appliance, Internet appliance, personal digital assistant (PDA), grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but may not be involved in the actual filling of the form (e.g., the user may not manually specify answers to fields but rather they may be automatically completed). The present specification provides various examples of operations being automatically performed in response to actions the user has taken.

Development Process—refers to the life cycle for development based on a methodology. At a coarse level it describes how to drive user requirements and constraints through design, implementation, verification, deployment, and maintenance.

Processing Element—the term “processing element” (PE) is used interchangeably with “processor” and refers to various elements or combinations of elements configured to execute program instructions. Processing elements include, for example, circuits such as an ASIC (Application Specific Integrated Circuit), entire processor cores, individual processors, and programmable hardware devices such as a field programmable gate array (FPGA).

### Overview

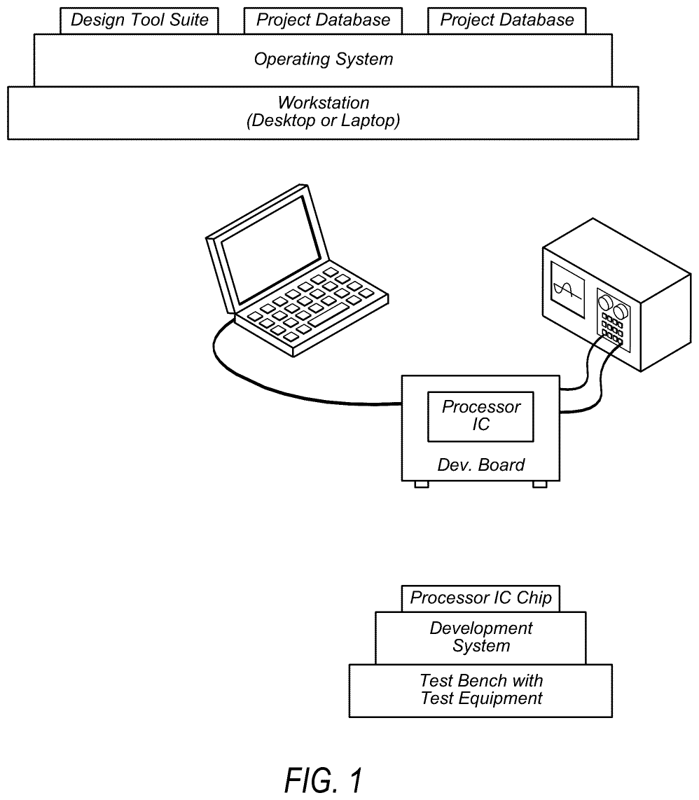

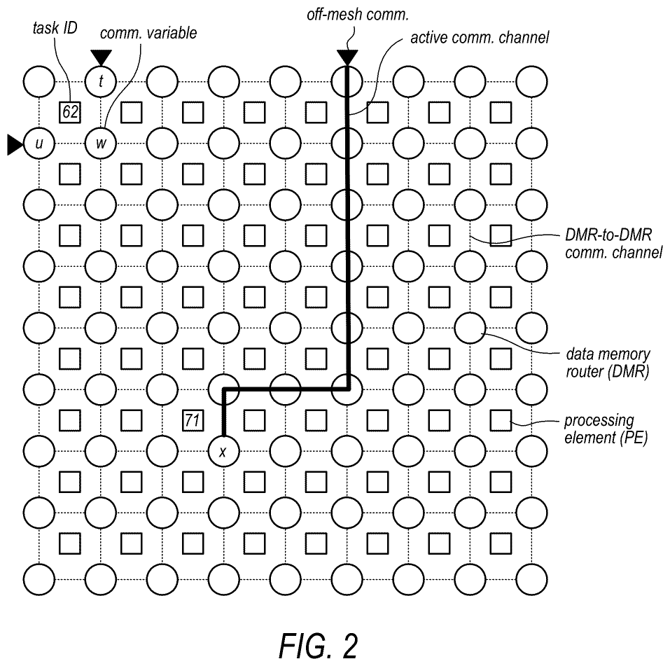

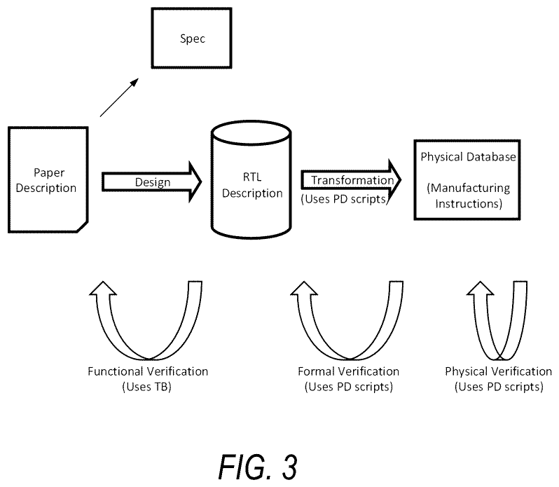

This disclosure describes, with reference to FIGS. 1-2, an overview of design and development for hardware modules of computing chips, which may consist of multiprocessor arrays (MPAs) and other circuit modules, in some embodiments. Embodiments of modular design flow techniques are described with reference to FIGS. 3-6.

The following describes various embodiments of a tool or toolkit, such as a programming language or programming language extension, for chip hardware development, including program instructions or commands specific to design, development, and of hardware for MPA and other chip systems. An MPA generally includes a plurality of processing elements, supporting memory, and a high bandwidth interconnection network (IN). Other terms used to describe an MPA may include a multiprocessor fabric or a multiprocessor mesh. In some embodiments, an MPA (or fabric/mesh) is a plurality of processors and a plurality of communication elements, coupled to the plurality of processors, where each of the plurality of communication elements may include a memory.

The toolkit may be used to implement modular, hierarchical design reuse of functions for fabricating a hardware module of a chip, and thus may allow a designer to create generalized functional module templates that can be configured and used in many different designs (or multiple times in the same design) thereby saving the effort needed to manually create situation-specific versions.

It should be noted that the techniques disclosed herein may be used in MPAs of various different array sizes. For example, in one exemplary embodiment, the MPA may include three or more PEs. In other exemplary embodiments, the size (number of PEs, supporting memory, and associated communication resources in the array) of the MPA may be greater than or equal to some specified number, which in various different embodiments may have any value desired, e.g., 4, 8, 16, 24, 32, 64, etc. More generally, depending on the particular application or use, the number of PEs in the MPA may have a specified lower bound, which may be specified to be any plural value, as desired. The described embodiments may also be used for design and fabrication processes for types of hardware modules other than MPAs, as desired.

### Hardware Development for Chips Hardware Modules

A hardware development project is the combination of human and machine work to generate the software that provides manufacturing instructions to fabricate a hardware component of a computing device. Generally, more design and test automation is beneficial because it allows for more testing of the generated software and thus may eliminate more bugs.

A hardware development environment for embedded systems is pictured in FIG. 1. Apart from the human software engineers and programmers, FIG. 1 shows two main parts to the development environment: the workstation and the test bench.

In some embodiments, a test bench is configured to generate test pattern inputs for the device under test (DUT) and capture the outputs of the DUT and compare to known good patterns. The closer the DUT matches the final product the higher is the confidence that the developed software will operate as expected in the final product. In some embodiments, the test bench performs simulated DUT stimulation of a hardware module based on an RTL description of the hardware module.

A workstation may be a desktop or laptop computer, for example, with an operating system (OS) that manages the details of mass storage, a database of design data, and a set (or suite) of design tools that read and write the project database. There may be more than one project and more than one project database and tools and libraries can be shared between them to lower development costs.

Typically, the memory for computers and DSPs is organized in a hierarchy with fast memory at the top and slower but higher capacity memory at each step down the hierarchy. In some embodiments of an MPA, supporting memories at the top of the hierarchy are located nearby each PE. In some embodiments, each supporting memory may be specialized to hold only instructions or only data. In other embodiments, supporting memories may store both instructions and data. Supporting memory for a particular PE may be private to that PE or shared with other PE.

Further down the memory hierarchy there may be a larger shared memory (e.g., semiconductor SDRAM) with a bit capacity many times larger than that of the supporting memory adjacent to each PE. In some embodiments, storage elements such as flash memory, magnetic disks, or optical disks may be accessible further down the memory hierarchy.

As noted above, a multiprocessor array (MPA) in some embodiments includes an array of processing elements (PEs), supporting memories (SMs), and a primary interconnection network (PIN or simply IN) that supports high bandwidth data communication among the PEs and/or memories. An exemplary MPA is illustrated in FIG. 2, described below. In some embodiments, a PE has registers to buffer input data and output data, an instruction processing unit (IPU), and means to perform arithmetic and logic functions on the data, plus a number of switches and ports to communicate with other parts of a system. In these embodiments, the IPU fetches instructions from memory, decodes them, and sets appropriate control signals to move data in and out of the PE and to perform arithmetic and logic functions on the data. PEs suitable for large MPAs are often selected or designed to be more energy efficient than general purpose processors (GPP), because of the large number of PEs per IC chip that contains a large MPA.

As used herein, the term MPA covers both relatively homogeneous arrays of processors, as well as heterogeneous collections of general purpose and specialized processors that are integrated on so-called “platform IC” chips. Platform IC chips also typically have many kinds of I/O circuits to communicate with many different types of other devices.

One example MPA architecture is the HyperX™ architecture discussed in U.S. Pat. No. 7,415,594, which is hereby incorporated by reference in its entirety, as though fully set forth herein. In one embodiment of the HyperX™ architecture, a multiprocessor array with a wide range of sizes may be composed of a unit-cell-based hardware fabric (mesh), wherein each cell is referred to as a HyperSlice. The hardware fabric may be formed by arranging the unit-cells on a grid and interconnecting adjacent cells. Each HyperSlice may include one or more data memory and routers (DMRs) and one or more processing elements (PEs). In U.S. Pat. No. 7,415,594 a DMR is referred to as a dynamically configurable communication (DCC) element, and a PE is referred to as a dynamically configurable processing (DCP) element. In this embodiment, the DMR may provide supporting memory for its neighboring PEs, as well as routers and links for the interconnection network (IN).

The hardware fabric may be created by abutting HyperSlices together, which involves aligning the HyperSlices to form correct electrical connections. These connections include links to DMRs and connections to a power supply grid. The techniques of replicating the HyperSlices, aligning them, and connecting by abutment are well understood techniques of very large scale integration (VLSI) of integrated circuits (IC) chips, especially ICs fabricated with complementary metal oxide semiconductor (CMOS) circuit technology. In this embodiment, the hardware fabric has a PIN that operates independently and transparently to the processing elements, and may provide on-demand bandwidth through an ensemble of real-time programmable and adaptable communication pathways (which may be referred to as routes or channels) between HyperSlices supporting arbitrary communication network topologies. Coordinated groups of HyperSlices may be formed and reformed “on-the-fly” under software control. This ability to dynamically alter the amount of hardware used to evaluate a function may allow for efficient or optimal application of hardware resources to relieve processing bottlenecks. At the edge of the hardware fabric, links may connect to circuits specialized for types of memory that are further down the memory hierarchy, or for I/O at the edge of an integrated circuit (IC) chip.

The interconnected DMRs may provide nearest-neighbor, regional, and global communication across the chip and from chip to chip. Each of these communication modes may physically use the DMR resources to send data/messages differently depending on locality of data and software algorithm requirements. A “Quick Port” facility may be provided to support low latency transfer of one or more words of data from a processor to any network destination. For block transfers, Direct Memory Access (DMA) engines within the DMR may be available to manage the movement of data across the memory and routing fabric. For nearest-neighbor communication between PEs, the use of shared memory and/or registers may be the most efficient method of data movement. For regional and global data movement, using the routing fabric (the PIN) may be the most efficient method. Communication pathways (or routes) can either be dynamic or static. Dynamic routes may be set up for data transfer and torn down upon the completion of the transfer to free up PIN resources for other routes and data transfers. Static routes may remain in place throughout the program execution and are primarily used for high priority and critical communications. The physical location of communication pathways and the timing of data transfers across them may be under software program control. Multiple communication pathways may exist to support simultaneous data transfer between any senders and receivers.

The architecture of the DMR may allow different interchangeable PEs to be used in a multiprocessor fabric to optimize the system for specific applications. A HyperX™ multiprocessor system may comprise either a heterogeneous or homogeneous array of PEs. A PE may be a conventional processor, or alternatively a PE may not conform to the conventional definition of a processor. A PE may simply be a collection of logic gates serving as a hard-wired processor for certain logic functions where programmability is traded off for higher performance, smaller area, and/or lower power.

FIG. 2 illustrates a view of the network of processing elements (PE's) and Data Memory Routers (DMRs) of one exemplary embodiment of a HyperX™ system. The PE's are shown as rectangular blocks and the DMRs are shown as circles. The routing channels between DMRs are shown as dotted lines. In the illustrated embodiment, solid triangles show off-mesh communication (which may also be referred to as chip inputs and/or outputs) and solid lines show active data communication between DMRs. A computational task is shown by its numerical identifier and is placed on the PE that is executing it. A data variable being used for communication is shown by its name and is placed on the DMR that contains it. In the illustrated example, the top left PE has been assigned a task with task ID 62, and may communicate with other PEs or memory via the respective DMRs adjacent to the PE, designated by communication path variables t, w, and u. As also shown, in this embodiment, an active communication channel connects a PE designated 71 (e.g., another task ID) to an off-mesh communication path or port. In some embodiments, PEs may communicate with each other using both shared variables (e.g., using neighboring DMRs) and message passing along the IN. In various embodiments, software modules developed according to the techniques disclosed herein may be deployed on portions of the illustrated network.

In some embodiments, a multiprocessor system is implemented on a chip. The chip may include multiple I/O routers for communication with off-chip devices, as well as an interior multiprocessor fabric, similar to the exemplary system of FIG. 2. A HyperX™ processor architecture may include inherent multi-dimensionality, but may be implemented physically in a planar realization as shown. The processor architecture may have high energy-efficient characteristics and may also be fundamentally scalable (to large arrays) and reliable-representing both low-power and dependable notions. Aspects that enable the processor architecture to achieve this performance include the streamlined processors, memory-network, and flexible IO. In some embodiments, the processing elements (PEs) may be full-fledged DSP/GPPs and based on a memory to memory (cacheless) architecture sustained by a variable width instruction word instruction set architecture that may dynamically expand the execution pipeline to maintain throughput while simultaneously maximizing use of hardware resources.

In some embodiments, the multiprocessor system includes MPA inputs/outputs which may be used to communicate with general-purpose off-mesh memory (e.g., one or more DRAMs in one embodiment) and/or other peripherals.

Software is the ensemble of instructions (also called program code) that is required to operate a computer or other stored-program device. Software can be categorized according to its use. Software that operates a computer for an end user for a specific use (such as word processing, web surfing, video or cell phone signal processing, etc.) may be termed application software. Application software includes the source program and scripts written by human programmers, a variety of intermediate compiled forms, and the final form called run time software may be executed by the target device (PE, microprocessor, or CPU). Run time software may also be executed by an emulator which is a device designed to provide more visibility into the internal states of the target device than the actual target device for the purposes of debugging (error elimination).

For multiprocessors systems there is an important extra step compared to a single processor system, which is the allocation of particular processing tasks or modules to particular physical hardware resources-such as PEs and the communication resources between and among PEs and system I/O ports. Note that resource allocation may include allocation of data variables onto memory resources, because allocation of shared and localized memory may have an impact on allocation of the PE and communication resources, and vice versa. This extra step is referred to as “resource allocation”. The resource allocation part of the flow may utilize a placement and routing tool, which may be used to assign tasks to particular PE in the array, and to select specific ports and communication pathways in the IN. These communication pathways may be static after creation or dynamically changing during the software execution. When dynamic pathways are routed and torn down during normal operation, the optimization of the system can include the time dimension as well as space dimensions. Additionally, optimization of the system may be influenced by system constraints, e.g. run-time latency, delay, power dissipation, data processing dependencies, etc. Thus, the optimization of such systems may be a multi-dimensional optimization.

When fewer processors are involved, the assignment of application software tasks to physical locations and the specific routing of communication pathways may be relatively simple and may be done manually. Even so, the workload of each processor may vary dramatically over time, so that some form of dynamic allocation may be desirable to maximize throughput. Further, for MPAs with large numbers of PEs, this assignment and routing process can be tedious and error prone if done manually. To address these issues software development tools for multiprocessor systems may define tasks (blocks of program code) and communication requirements (source and destination for each pathway) and automatically allocate resources to tasks (place and route). If a design is large or contains many repeated tasks it may be more manageable if expressed as a hierarchy of cells. However, a hierarchical description will generally have to be flattened into a list of all the tasks and all the communication pathways that are required at run time before the place and route tools can be used to complete the assignment and routing process.

The idea of hierarchical, configurable cells has been used in the area of Hardware Description Languages (HDLs). Hierarchical configurability is built into commonly used HDLs such as Verilog and VHDL. However, those HDLs are oriented toward creating designs that are implemented in logical gates and are not usually utilized in programming a multiprocessor array. The major differences are the models of computation used in each domain. In the HDL model, all the computation resources typically default to concurrent execution, but can be specified for sequential execution. The multiprocessor model typically assumes a restricted number of streams of parallel computation, each of which may follow a sequential execution model.

Such HDLs have no representations of the unique properties of multiprocessor arrays, e.g., unique or shared memory spaces, unique or shared synchronization resources, or sets of processor specific machine instructions. In contrast, software languages for multiprocessors typically include representations of these features.

In the field of software languages, function configurability has been utilized for some time. However, prior art software programming languages do not support programming reusability (of both fixed and reconfigurable cells) and managing design complexity with hierarchical decomposition. For example, the construct known as “templates” in C++ allows a function to be specialized for a particular use; however, the range of parameterization is limited to the data types of its arguments and does not allow changes in the parallel implementation of the computation, e.g., on an MPA.

The resource allocation of a cell on an MPA may also be sensitive to parameters. For example, a cell may be designed with a parameter that may determine whether it was laid out linearly or in a rectangular form. As another example, the parameter may represent a bounding box of the resources onto which the cell is designed to be allocated.

### FIG. 3—Workflow for Specification Data Structure and Manufacturing Instructions

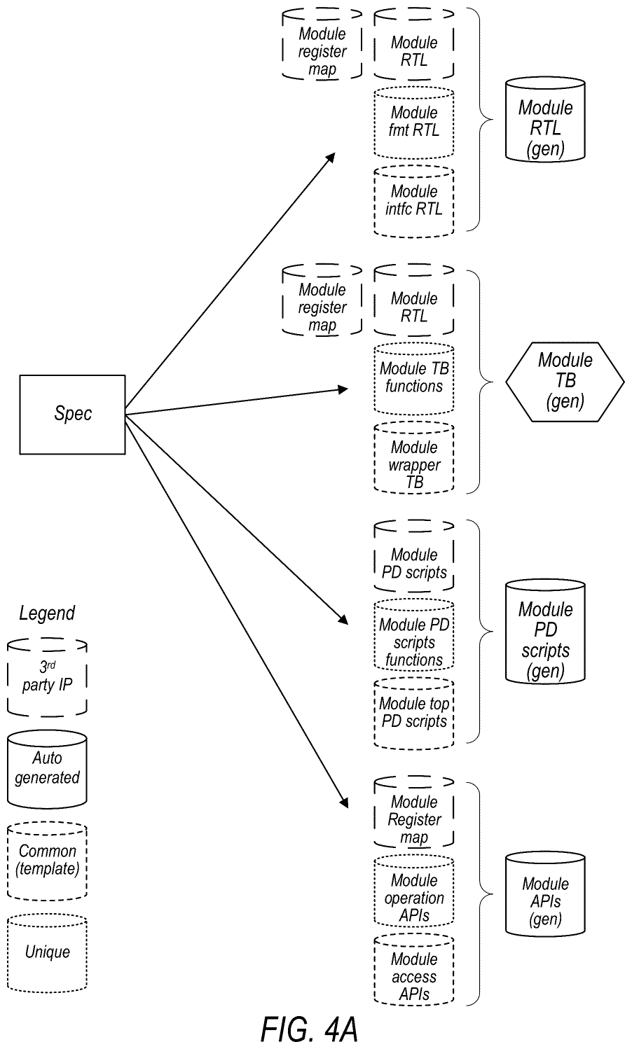

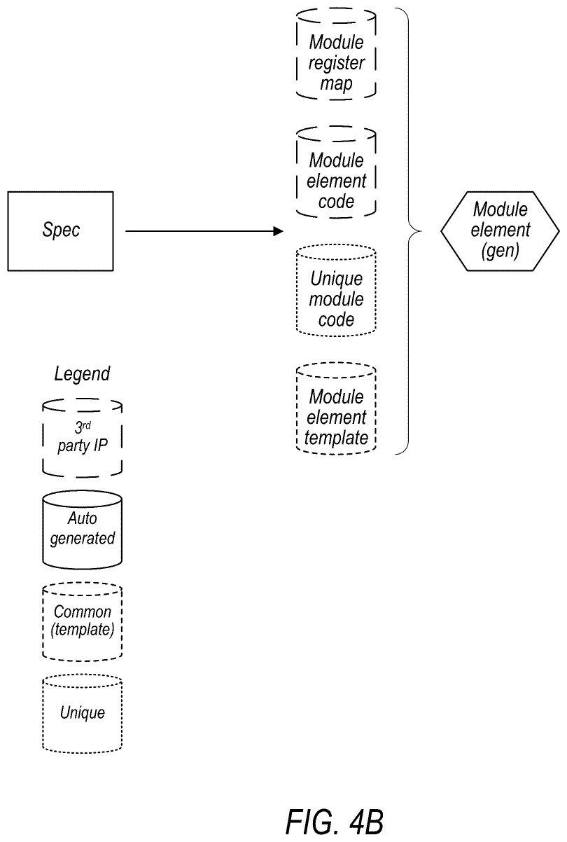

FIG. 3 is a diagram illustrating a workflow for constructing a specification data structure and manufacturing instructions, according to some embodiments. As illustrated, a paper description is received of a hardware module of a chip or MPA. The paper description is a document describing the specifications and desired functionality for the hardware module being designed. A specification data structure, “Spec”, is constructed based on the paper description, as described in greater detail below, and is the same Spec described in FIG. 4A. Historically, the RTL description has been developed through traditional coding and development means by engineers manually writing the RTL description. The RTL description may be generated in an automated manner based on the Spec, by using the modular design flow methods described herein.

Functional Verification may be performed on the RTL description to verify that the RTL functionally matches the specifications and desired functionality described in the Paper Description. The TB (Test Bench) is used to perform this functional verification. The TB may simulate the desired functionality, and measure a simulated response using the RTL description.

The RTL description may be transformed into a physical database of manufacturing instructions using a physical design (PD) script that is also generated by the Spec. The physical database is a set of manufacturing instructions to be provided to the foundry (e.g., GlobalFoundries or TSMC) for them to use, e.g., to create a mask set that is used to fabricate the chip or hardware module. The process of transforming the RTL into the physical database is often called “physical design” and may be accomplished using EDA (Electronic Design Automation) tools, which are third-party software programs that automate the chip design and verification process. The PD scripts are used to sequence and control the EDA tools, which are generic, to accomplish the desired development and verification process for the specific chip being designed.

Formal Verification may be performed on the physical database, which is a process of verifying that the Physical Database is functionally equivalent to the RTL description. This process is part of the physical design process and is controlled by PD scripts. Physical Verification may also be performed, which is the process of verifying that the Physical Database is internally consistent. There are three main objectives of this internal consistency check: (1) verifying that the database meets performance objectives (typically speed and power), (2) verifying that the database follows the manufacturing specifications provided by the foundry, and (3) verifying that the database meets long term reliability and manufacturing objectives. This process is part of the physical design process and is controlled by PD scripts. The verified physical database (manufacturing instructions) may then be provided to a foundry to fabricate a photomask that is useable to construct the hardware module.

### Modular Design Flow

In some embodiments, a computer program is used to generate design elements (hardware modules) of a computer chip using information in a specification and a database of templates. The design elements may also be generated using third-party IP data inserted into a database in a compatible manner as well as unique design elements constructed for the project based on integration specifications of each third-party IP module or custom module.

In some embodiments, the computer program may not be a monolithic program but may be a set of individual computer programs with functions targeting different aspects of the module generation process. The term “Module Builder” will be used herein to generally refer to the entire module-generating program.

Module Builder can be used to generate one or more Module Elements needed to support the chip design process. FIG. 4A shows the construction of four exemplary types of Module Elements: a register transfer language (RTL) description, a test bench (TB), physical design (PD) scripts, and application programing interfaces (APIs). These terms are defined below.

RTL stands for “Register Transfer Language,” which is a hardware description language used to describe hardware circuit operation. Examples are Verilog and VHDL. Parameters within the specification data structure may provide Module Builder with a variety of possible pieces of information, such as parameters to control selection of options within one of the RTL templates, parameters to specify how submodules should be connected, and/or parameters to specify how the module being generated may be connected to other modules in the chip.

TB stands for “Test Bench,” which is a description of an environment to test the functionality of a module. It can be written in a variety of programming languages. One example is System Verilog. The test bench may perform a simulated stimulation and examination of simulated responses of the RTL description to probe the functionality of a hardware module constructed based on the RTL description.

PD stands for “Physical Design,” which is the process for transforming the RTL description of a module into a layout database which describes a physical schematic for the hardware module. The layout database may be provided to the foundry, which uses this information to generate the tooling (i.e., masks) used to manufacture the hardware module of the chip.

API stands for “Application Programming Interface,” which is a set of functions used to control, configure, obtain status, and operate a chip or a portion of a chip. These functions may be written in a computer programming language (e.g., C, C++, Python, etc.).

EDA stands for “Electronic Design Automation,” which is a class of computer programs used to automate the chip design process. They are often referred to as “EDA tools” and can be obtained from different third parties or can be proprietary programs.

As shown in FIG. 4A, arrows indicate that information comes from the specification data structure (Spec) to be used by Module Builder to generate one of the indicated Module Elements based on the databases needed to build that specific Module Element. The set of Module Elements collectively provide the information to design, verify, and program a single module (or in the case of a multi-level hierarchical chip implementation, a single submodule). The various modules and submodules that construct a hierarchical chip will each have a set of Module Elements, as will the chip itself.

FIG. 4A shows separate database elements for the generation of each Module Element. This is pictured this way for convenience. The entire set of database elements can be viewed as one logical database, with common elements used for the generation of multiple Module Elements. The database may be implemented in a variety of ways, for example, it may be a single monolithic database implemented using relational database techniques, or another database implementation technique may be used.

In some embodiments, Module Builder may have knowledge of different Module Elements, different types of modules, and the parameters associated with each. This knowledge may be used to apply the parameters to the templates in the database to generate the appropriate Module Element. Module Builder, the Spec, and the template database may be extendible to additional Module Elements and module types. Any non-generated item in the diagram in FIG. 4A may be considered to be a template for use by Module Builder.

The module depicted in FIG. 4A is part of a hierarchical chip design. The concepts outlined can be applied to any module at any level of the hierarchy, including the top level, which is the entire chip.

The following paragraphs define various aspects shown in FIG. 4A.

Spec-“specification data structure”-A database of parameters used to specify which modules will be in the desired chip and how they should be configured. The specific parameters will be module-dependent and may change from one version of a module to another. The database may be stored in a variety of file formats. One possible example is the XML format, though other file formats may also be used, as desired.

### Generating the RTL Module Element:

Module RTL-RTL code for a specific module, which may be parameterized. In the diagram, this block is bordered with long dashes to indicate that it is RTL code for IP licensed from a third party. In some cases, when the block is a common template, it is bordered in short dashes to indicate that it is a module used as a common design element.

Module register map—A database of control, status, and configuration registers used within the module. The register map will contain information describing the structure of the registers and how they are accessed (including addressing information). The register map database may not be delivered directly in the correct format from the third party, in which case the information may be first reformatted to be compatible with Module Builder. Note that the same Module register map is used to generate other Module Elements.

Module format (fmt) RTL-RTL code that provides unique functionality needed to format the interfaces from the Module RTL to a standard template format compatible with other templates within the database, specifically so that the Module interface (intfc) RTL template can be used by Module Builder to generate the RTL for the module as the output of the process.

Module intfc RTL-RTL code that consists of a template compatible with Module Builder that instantiates Module RTL and Module fmt RTL with the appropriate connections to provide the desired functionality of the module being generated and to provide the desired interfaces to the rest of the chip (i.e., other modules).

Module RTL generated (gen)—The RTL code generated by Module Builder. This is the output of the process.

### Generating the TB Module Element

“Module TB” is code for the TB to test the functionality of a specific module. The TB may be parameterized.

Module register map—A database of control, status, and configuration registers used within the module. The register map may contain information describing the structure of the registers and how they are accessed (including addressing information). The register map database may not be delivered directly in the correct format from the third party, in which case the information may be reformatted to be compatible with Module Builder. Note that the same Module register map is used to generate other Module Elements.

Module TB functions-Auxiliary functions providing unique capability for the TB to test the specific module. This may include bus functional models, which are models of modules external to the specific module being tested used to check correct functionality of the interface between the specific module and the external module.

Module wrapper TB—TB code that consists of a template compatible with Module Builder that instantiates Module TB and Module TB functions with the appropriate connections to provide the desired test environment for the module being generated.

Module TB generated (gen)—The TB code generated by Module Builder. This is the output of the process.

Parameters within the Spec may provide Module Builder with a variety of possible pieces of information, such as parameters to control selection of options within one of the TB templates, parameters to specify how submodules should be connected, parameters to specify how the module being generated should be connected to the TB, parameters to specify different bus functional models and how they should be connected within the TB, parameters to specify different auxiliary functions and how they should be used within the TB, and/or parameters to specify how different registers within the Module register map should be tested.

Generating the PD script Module Element

Module PD scripts—Sets of computer programs (scripts) used by the PD process to control and configure the operation of a set of EDA tools through different steps or phases. The scripts may be parameterized.

Module PD script functions—Auxiliary functions providing unique capabilities for different steps or phases of the PD process by one or more EDA tools.

Module top PD scripts—PD script code that consists of a template compatible with Module Builder that instantiates Module PD scripts and Module PD script functions with the appropriate sequence to provide the desired PD flow for the module being generated.

Module PD scripts (gen)—The PD scripts generated by Module Builder. This is the output of the process.

### Generating the API Module Element

Module register map—A database of control, status, and configuration registers used within the module. The register map will contain information describing the structure of the registers and how they are accessed (including addressing information). The register map database may not be delivered directly in the correct format from the third party, in which the information may be reformatted first to be compatible with Module BuilderNote that the same Module register map is used to generate other Module Elements.

Module operation APIs—Auxiliary functions providing unique capabilities to control, configure, obtain status, or operate some portion of the module being generated.

Module access APIs—API code that consists of a template compatible with Module Builder that instantiates Module operation APIs with the appropriate sequence and parameters to provide the desired set of APIs for the module being generated.

Module APIs (gen)—The API code generated and output by the Module Builder.

API functions may be used by a programming environment to provide programming capability for the chip or may be used in a computer program running on the chip.

3rd party IP [long dash borders]—Indicates that the source of the information, code, etc. is from a third party received as part of a license to use the Intellectual Property (“IP”). The source of the information is not relevant to the claims in the invention other than there will be work required to import information from third parties into the database.

Auto generated [solid line borders]—Indicates that the information, code, etc. is generated by Module Builder.

Common (template) [short dash borders]—Indicates that the information, code, etc. is part of the database and is used as source material for Module Builder.

Unique [dotted borders]—Indicates that the information, code, etc. is unique to a particular module and requires work to not only import this information into the database, but also work to develop the information.

### FIG. 4B—Simplified Modular Design Flow

FIG. 4B is a flowchart that shows utilization of a specification data structure to construct a Module Element, which may be one of the four types of Module Elements described in reference to FIG. 4A. These four Module Elements are not exhaustive, and some embodiments may apply the described methods to additional Module Elements.

### Generating the Module Element

Module register map—A database of control, status, and configuration registers used within the module. The register map will contain information describing the structure of the registers and how they are accessed (including addressing information). The register map database may not be delivered directly in the correct format from a third party, in which the information may be reformatted to be compatible with Module Builder.

Module Element Code—Code for a specific module, which may be parameterized.

In the detailed figure, this maps to “Module RTL” for the RTL Module Element, “Module TB” for the TB Module Element, and “Module PD scripts” for the PD script Module Element.

Unique Module Code—Code that provides unique functionality needed for the Module Element to function or operate within its intended context.

In the detailed figure, this maps to “Module fmt RTL” for the RTL Module Element, “Module TB functions” for the TB Module Element, “Module PD script functions” for the PD script Module Element, and “Module operation APIs” for the API Module Element.

Module Element Template—Code that consists of a template compatible with Module Builder that instantiates Module Element Code and Unique Module Code with the appropriate connections, sequences, and/or parameters to provide the desired interfaces, flow, APIs, and/or environment for the module being generated.

In the detailed figure, this maps to “Module intfc RTL” for the RTL Module Element, “Module wrapper TB” for the TB Module Element, “Module top PD scripts” for the PD script Module Element, and “Module access APIs” for the API Module Element.

Module Element (gen)—The code generated by Module Builder. This is the output of the process. “gen” is short for “generated.”

In the detailed figure, this maps to “Module RTL (gen)” for the RTL Module Element, “Module TB (gen)” for the TB Module Element, “Module PD scripts (gen)” for the PD script Module Element, and “Module APIs (gen)” for the API Module Element.

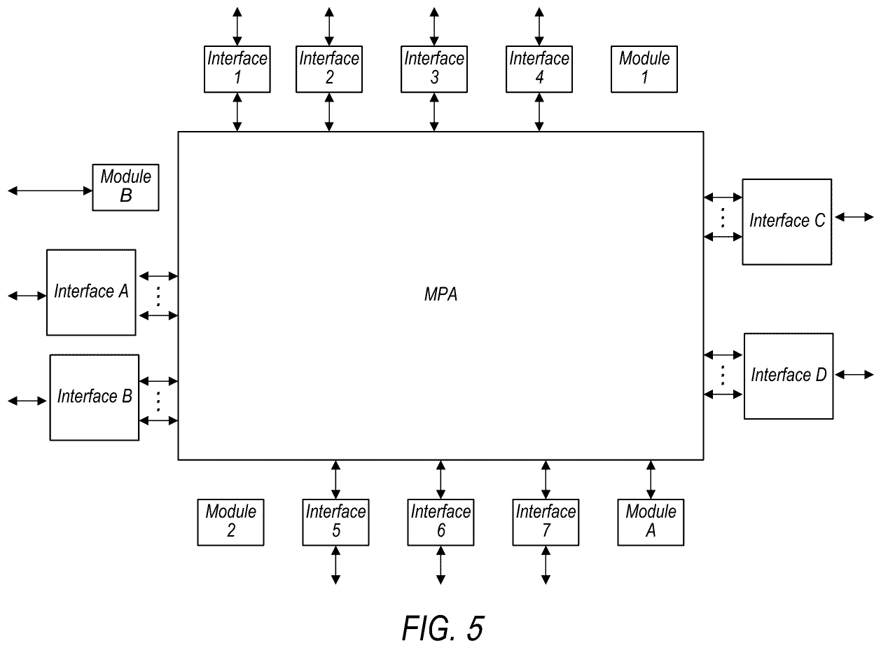

### FIG. 5—MPA Interface Connections

FIG. 5 is a schematic diagram of an MPA that includes connections with a plurality of interfaces, according to some embodiments. As illustrated, the interfaces 1-7 are modules that provide input to and/or receive output data from the MPA using a single respective connection to the MPA. The interfaces 1-7 also each have an I/O connection to other parts of the computing system outside of the MPA chip. Interfaces A-D are similar to the interfaces 1-7, except that the interfaces A-D each have multiple connections with the MPA chip. The interfaces may be PCIe interfaces, ethernet interfaces, or another type of interface, in various embodiments.

FIG. 5 also illustrates modules 1-2 that are not connected to the MPA, and do not have input and/or output data streams from other parts of the system separate from the MPA chip. Module A is connected to the MPA, but does not have input and/or output data streams from other parts of the system separate from the MPA chip. Module B is not connected to the MPA, but does have input and/or output data streams from other parts of the system separate from the MPA chip. Module B may be a clocking module or a debug port, in some embodiments. Each of the illustrated interfaces and modules shown in FIG. 5 may include submodules, in some embodiments.

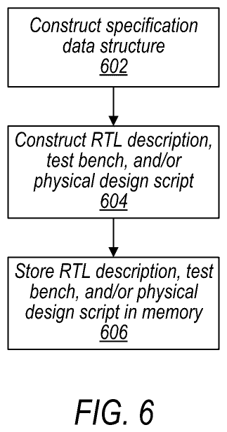

### FIG. 6—Flowchart for Specification Data Structure

FIG. 6 is a flowchart diagram illustrating a method for constructing and utilizing a specification data structure, according to some embodiments. The method shown in FIG. 6 may be used in conjunction with any of the computer systems or devices shown in the above Figures, among other devices. For example, in some embodiments one or more process operations of FIG. 6 may be performed by devices including a processor coupled to a non-transitory memory medium, where the processor executes program instructions stored on the memory to perform the described method steps. The processor may be part of a computer system that is configured to receive user input to direct the method steps. In various embodiments, some of the method elements shown may be performed concurrently, in a different order than shown, or may be omitted. Additional method elements may also be performed as desired. As shown, this method may operate as follows.

At 602, a specification data structure is constructed for a module. The specification data structure may include parameters for combining a plurality of module element templates for submodules of the hardware module into a module element of the hardware module. The hardware module (or “module”) may be a computer chip (such as a multiprocessor array (MPA) as described herein in reference to FIG. 2) or a component of a computer chip (such as a DMR, an individual processor of an MPA, an input and/or output port, an interface, etc.). The module may be a smaller component or subset of a computer chip, in some embodiments. The module element may be any of the four types of module elements shown in FIG. 4A, or another type of module element. As used herein, “module element” refers to software code that is useable for the design, verification, and/or fabrication process for a hardware module.

In some embodiments, each module element template corresponds to a respective submodule of the module, where each submodule is one of a processing element (PE), a data memory router (DMR), a message network node (MNN), a clocking device, or an input/output (I/O) interface, among other possibilities. As one example, the module may be an MPA or a portion of an MPA that includes an interspersed plurality of PEs with interconnecting DMRs. In this case, the PEs and the DMRs are the submodules of the MPA or the portion of the MPA, and there may be one or more module element templates associated with each of the PEs and the DMRs. A single module element template may be associated with each of multiple PEs, or there may be two or more distinct types of PEs with distinct module element templates associated with them, in various embodiments.

Note that each submodule may have a module element template for multiple domains. For example, a PE may have an RTL template, a test bench template, a physical design script template, and/or an API template.

At 604, the module element is constructed. Constructing the module element is performed based at least in part on the specification data structure and the plurality of module element templates. As one example, elements of the specification data structure may be mapped onto an RTL template to construct an RTL description.

More broadly, in some embodiments, constructing the module element based on the specification data structure and the plurality of module element templates involves mapping elements of the specification data structure onto respective module element templates.

In some embodiments, constructing the module element based on the specification data structure and the plurality of module element templates involves selecting a configuration for one or more module element templates based on the parameters in the specification. For example, the templates may have configurable parameters, and the specification data structure may specify values for one or more of these parameters. As one example of a configurable parameter, the module element template for the RTL of a PE may be designed to accommodate both the presence and absence of certain functional operations (one example might be support for floating point arithmetic). The configurable parameter in the specification data structure associated with these instructions can be used to select the appropriate sections of the RTL template to construct the proper RTL description. This same configurable parameter can also be used to construct the proper TB module element so that the RTL description can be verified. This same concept can be applied to other types of module elements and other modules.

In some embodiments, constructing the module element based on the specification data structure and the plurality of module element templates involves establishing connections between two or more module element templates based on the parameters. As one example of establishing connections between two or more module element templates, the module element for the RTL of the chip (i.e., the RTL description) may be designed to accommodate connections of I/O interfaces to any DMR. The specification data structure can have information that specifies which DMR a certain I/O interface should be connected to. In this example, the RTL description for the chip will be constructed to connect the specific DMR and I/O interface as described in the specification data structure. Similarly, the TB module element for the chip may be constructed with this same connection so that the RTL description for the chip can be verified.

At 606, the module element is stored in a non-transitory computer-readable memory medium. The specification data structure may also be stored in the memory medium, in some embodiments.

In some embodiments, the module element templates are register transfer language (RTL) templates, and the module element is an RTL description of the module. The RTL description is a functional description of the module, and may include a functional description of memory blocks, routing behavior, queuing behavior, and/or arbitration of computing resources for the module, as one example. It may include a description of Boolean relations between aspects of the module such as memory blocks and data routing.

In some embodiments, the specification data structure includes parameters for combining module element templates into module elements in one or more additional domains, such as test bench, physical design script, or application programming interface (API).

For example, the specification data structure may include parameters for combining a plurality of test bench templates for the respective submodules into a test bench for the module. The method may include constructing the test bench based at least in part on the specification data structure and the plurality of test bench templates, and storing the test bench in the non-transitory computer-readable memory medium. The test bench is used for functional verification of the RTL description. For example, the test bench may be used to simulate application of a stimulus to the module based on the functional relations of the RTL description and monitor simulated responses to check whether the simulated response matches an expected response. This may be an iterative process whereby, if the expected response is not received, feedback may be provided to the user to modify the module design and/or specification data structure for construction of a new RTL description.

Additionally or alternatively, the specification data structure may include parameters for combining a plurality of physical design script templates for the respective submodules into a physical design script for the module. The method may include constructing the physical design script based at least in part on the specification data structure and the plurality of physical design script templates, and storing the physical design script in the non-transitory computer-readable memory medium. In some embodiments, the module elements (e.g., RTL description, the test bench, the physical design script, and/or the API) are useable by electronic design automation (EDA) tools in a physical design process for the module. For example, the EDA may use instructions in the physical design script to transform the RTL description into manufacturing instructions for the module. In some embodiments, the manufacturing instructions are instructions for a foundry to construct a photomask, where the photomask is then used by the foundry to fabricate the module or chip. The photomask may be a plate with a spatially-variable opacity, which allows laser light to shine through in specific areas, e.g., to enable selective laser etching for silicon chip fabrication. The manufacturing instructions may be stored in a database, which may be variously referred to as a photomask database or a physical design database. The physical design process is the process of transforming the RTL description into the manufacturing instructions using an EDA tool executing the physical design script. For example, EDA tools use configuration, sequencing and control information, which is provided by the physical design script, to transform the RTL description into manufacturing instructions. For example, Boolean relations described in the RTL description may be synthesized into a physical schematic for the module. The physical schematic may then place gates spatially within the module and route connections, as one example.

The physical design script may also be useable by the EDA tools to perform formal verification and/or physical verification. Formal verification verifies that the manufacturing instructions are functionally consistent with the RTL description. Physical verification ensures that the manufacturing instructions are internally consistent, meet performance requirements such as speed and power, and/or follow manufacturing rules received from the foundry. Advantageously, embodiments herein describe a physical design process that is controlled by physical design scripts that are created in a modular design flow, resulting in a more efficient and flexible design process.

Additionally or alternatively, the specification data structure may include parameters for constructing an API for the module based on a set of functional criteria for operation of the module. The method may include constructing the API based at least in part on the set of functional criteria and storing the API in the non-transitory computer-readable memory medium. In some embodiments, the module may be a programmable chip which can have code written for it, e.g. in C, C++ or another programming language. In order to facilitate methods for a programmer to probe a specific module on the chip, an API may be constructed with a set of functions to allow the programmer to more easily interact with aspects of the hardware module. For example, the API may abstract low-level details of chip functionality into a more readable format for the programmer. Module-specific details may be automatically generated based on the functional criteria to facilitate construction of the API.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
constructing a specification data structure for a module, wherein the specification data structure comprises:
parameters for combining a plurality of module element templates for submodules of the module into a module element of the module;
constructing the module element, wherein constructing the module element is performed based at least in part on the specification data structure and the plurality of module element templates; and
storing the module element in a non-transitory computer-readable memory medium.

2. The method of claim 1,
wherein the plurality of module element templates comprises a plurality of register transfer language (RTL) templates,
wherein the module element comprises an RTL description of the module.

3. The method of claim 2,
wherein constructing the module element based on the specification data structure and the plurality of module element templates comprises one or more of:
mapping elements of the specification data structure onto respective RTL templates of the plurality of RTL templates;
selecting a configuration for one or more RTL templates of the plurality of RTL templates based on the parameters; and
establishing connections between two or more RTL templates of the plurality of RTL templates based on the parameters.

4. The method of claim 2, further comprising:
constructing manufacturing instructions for the module using an electronic design automation (EDA) tool, wherein the EDA tool constructs the manufacturing instructions based on the RTL description and using a physical design script.

5. The method of claim 1,
wherein each template of the plurality of templates corresponds to a respective submodule of the module, wherein each submodule comprises one of:
a processing element (PE);
a data memory router (DMR);
a message network node (MNN);
a clocking device; or
an input/output (I/O) interface.

6. The method of claim 1,
wherein the specification data structure further comprises parameters for combining a plurality of test bench templates for the respective submodules into a test bench for the module, wherein the method further comprises:
constructing the test bench, wherein constructing the test bench is performed based at least in part on the specification data structure and the plurality of test bench templates; and
storing the test bench in the non-transitory computer-readable memory medium.

7. The method of claim 1,
wherein the specification data structure further comprises parameters for combining a plurality of physical design script templates for the respective submodules into a physical design script for the module, wherein the method further comprises:
constructing the physical design script, wherein constructing the physical design script is performed based at least in part on the specification data structure and the plurality of physical design script templates; and
storing the physical design script in the non-transitory computer-readable memory medium.

8. The method of claim 1,
wherein the specification data structure further comprises parameters for constructing an API for the module based on a set of functional criteria for operation of the module, wherein the method further comprises:
constructing the API, wherein constructing the API is performed based at least in part on the set of functional criteria; and
storing the API in the non-transitory computer-readable memory medium.

9. A non-transitory computer-readable memory medium storing program instructions which, when executed by a processor, cause the processor to:
construct a specification data structure for a chip, wherein the specification data structure comprises:
parameters for combining a plurality of register transfer language (RTL) templates for submodules of the chip into an RTL description of the chip;
parameters for combining a plurality of test bench templates for respective submodules into a test bench for the chip; and
parameters for combining a plurality of physical design script templates for respective submodules into a physical design script for the chip; and
store the specification data structure in the non-transitory computer-readable memory medium.

10. The non-transitory computer-readable memory medium of claim 9, wherein the program instructions are further executable to cause the processor to:
construct, based on the specification data structure and the pluralities of RTL, test bench and physical design script templates, the RTL description, the test bench and the physical design script;
store the RTL description, the test bench and the physical design script in the non-transitory computer-readable memory medium.

11. The non-transitory computer-readable memory medium of claim 10,
wherein, in constructing the RTL description, the test bench and the physical design script based on the specification data structure and the pluralities of RTL, test bench and physical design script templates, the program instructions are executable to cause the processor to:
map elements of the specification data structure onto respective templates of the pluralities of RTL, test bench and physical design script templates;
select options and/or a configuration for one or more templates of the pluralities of RTL, test bench and physical design script templates based on the parameters; and/or
establish connections between two or more templates of the pluralities of RTL, test bench and physical design script templates based on the parameters.

12. The non-transitory computer-readable memory medium of claim 10,
wherein the RTL description, the test bench and the physical design script are useable by a fabrication device to fabricate the module.

13. The non-transitory computer-readable memory medium of claim 9,
wherein each template of the pluralities of RTL, test bench and physical design script templates corresponds to a respective submodule, wherein each submodule comprises one of:
a processing element (PE);
a data memory router (DMR);
a message network node (MNN);
a clocking device; or
an input/output (I/O) interface.

14. The non-transitory computer-readable memory medium of claim 9,
wherein the specification data structure further comprises parameters for constructing an API for the chip based on a set of functional criteria for chip operation, wherein the program instructions are further executable to cause the processor to:
construct the API, wherein constructing the API is performed based at least in part on the set of functional criteria; and
store the API in the non-transitory computer-readable memory medium.

15. A non-transitory computer-readable memory medium storing program instructions which, when executed by a processor, cause the processor to:
construct a specification data structure for a module, wherein the specification data structure comprises:
parameters for combining a plurality of register transfer language (RTL) templates for submodules of the module into an RTL description of the module;
construct the RTL description, wherein constructing the RTL description is performed based at least in part on the specification data structure and the plurality of RTL templates; and
store the RTL description in the non-transitory computer-readable memory medium.

16. The non-transitory computer-readable memory medium storing program instructions of claim 15,
wherein the specification data structure further comprises parameters for combining a plurality of test bench templates for the respective submodules into a test bench for the module, wherein the program instructions are further executable to cause the processor to:
construct the test bench, wherein constructing the test bench is performed based at least in part on the specification data structure and the plurality of test bench templates; and
store the test bench in the non-transitory computer-readable memory medium.

17. The non-transitory computer-readable memory medium storing program instructions of claim 15,
wherein the specification data structure further comprises parameters for combining a plurality of physical design script templates for the respective submodules into a physical design script for the module, wherein the program instructions are further executable to cause the processor to:
construct the physical design script, wherein constructing the physical design script is performed based at least in part on the specification data structure and the plurality of physical design script templates; and
store the physical design script in the non-transitory computer-readable memory medium.

18. The non-transitory computer-readable memory medium storing program instructions of claim 15, wherein the program instructions are further executable to cause the processor to:
provide instructions to an electronic design automation (EDA) tool to construct manufacturing instructions for the module based on the RTL description and using the physical design script.

19. The non-transitory computer-readable memory medium storing program instructions of claim 15,
wherein, in constructing the RTL description based on the specification data structure and the plurality of RTL templates, the program instructions are executable to cause the processor to implement one or more of:
mapping elements of the specification data structure onto respective RTL templates of the plurality of RTL templates;
selecting a configuration for one or more RTL templates of the plurality of RTL templates based on the parameters; and
establishing connections between two or more RTL templates of the plurality of RTL templates based on the parameters.

20. The non-transitory computer-readable memory medium storing program instructions of claim 15,
wherein each RTL template of the plurality of RTL templates corresponds to a respective submodule of the module, wherein each submodule comprises one of:
a processing element (PE);
a data memory router (DMR);
a message network node (MNN);
a clocking device; or
an input/output (I/O) interface.
